(19) United States
(12) Patent Application Publication
(10) Pub. No.: US 2009/0006031 A1
(43) Pub. Date: Jan. 1, 2009

(54) COMBINATION LASER AND PHOTOGRAMMETRY TARGET

(75) Inventor: BOBBY J. MARSH, LAKE STEVENS, WA (US)

Correspondence Address: WILDMAN HARROLD ALLEN & DIXON LLP;AND THE BOEING COMPANY, 225 W. WACKER DR., CHICAGO, IL, 60606, US

(73) Assignee: THE BOEING COMPANY, CHICAGO, IL (US)

(21) Appl. No.: 12/188,023

(22) Filed: Aug. 7, 2008

Related U.S. Application Data
(62) Division of application No. 11/437,201, filed on May 19, 2006.

(51) Int. Cl. G01B 11/00

(52) U.S. Cl. 702/158

(57) ABSTRACT

The invention relates to the use of one or more targets in measuring surfaces. Each of the one or more targets may comprise a first portion adapted to reflect a laser beam towards a laser tracking device, and a second portion adapted to reflect a light beam towards a photogrammetry device. Simultaneous photogrammetry and laser tracking measurements may be taken utilizing the one or more targets.

### CROSS REFERENCE TO RELATED APPLICATION

This application claims priority to and is a divisional of U.S. patent application Ser. No. 11/437,201 filed on May 19, 2006, which is hereby incorporated by reference.

### BACKGROUND OF THE INVENTION

Photogrammetry devices are known in the art as being relatively useful for measuring large areas of surface in a relatively timely fashion. However, photogrammetry devices are known to have accuracy deficiencies. Conversely, laser tracking devices are known in the art as being relatively useful for taking accurate measurements at predetermined locations. However, laser tracking devices are known to have difficulties measuring large surface areas in a relatively timely fashion.

A target and method for its use is needed which may allow a surface to be measured simultaneously utilizing both photogrammetry and laser tracking to solve one or more problems in measuring surfaces with either photogrammetry or laser tracking alone.

### SUMMARY OF THE INVENTION

In one aspect of the invention, a target for use in measuring surfaces comprises a first portion adapted to reflect a laser beam towards a laser tracking device, and a second portion adapted to reflect a light beam towards a photogrammetry device.

In an other aspect of the invention, a measured surface is provided. The measured surface was measured utilizing at least one target. A location of the at least one target was simultaneously measured by both a laser tracking device and a photogrammetry device.

In a further aspect of the invention, a method is disclosed for measuring a surface. The method comprises providing a target, and concurrently measuring a location of the target utilizing laser tracking and photogrammetry.

These and other features, aspects and advantages of the invention will become better understood with reference to the following drawings, description and claims.

### BRIEF DESCRIPTION OF THE DRAWINGS

FIG. 1 is a perspective view of one embodiment of a target under the invention;

FIG. 2 is a perspective view showing a plurality of the target of FIG. 1 being distributed around a barrel of an airplane to measure a surface of the barrel; and

FIG. 3 depicts one embodiment of a method under the invention for measuring a surface.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

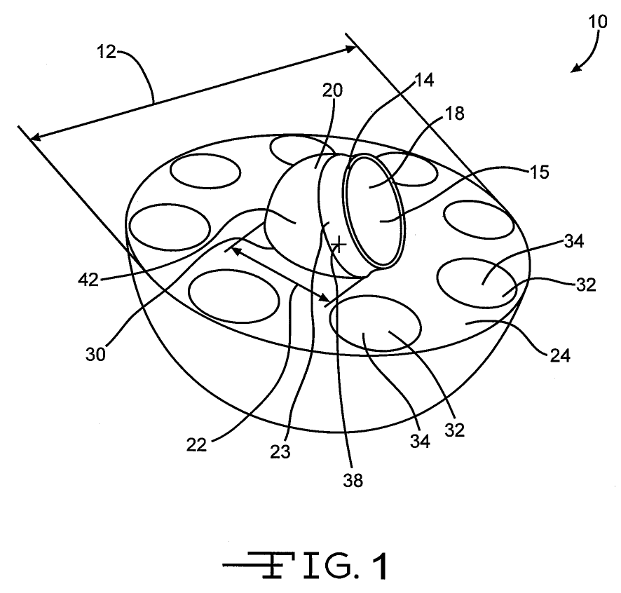

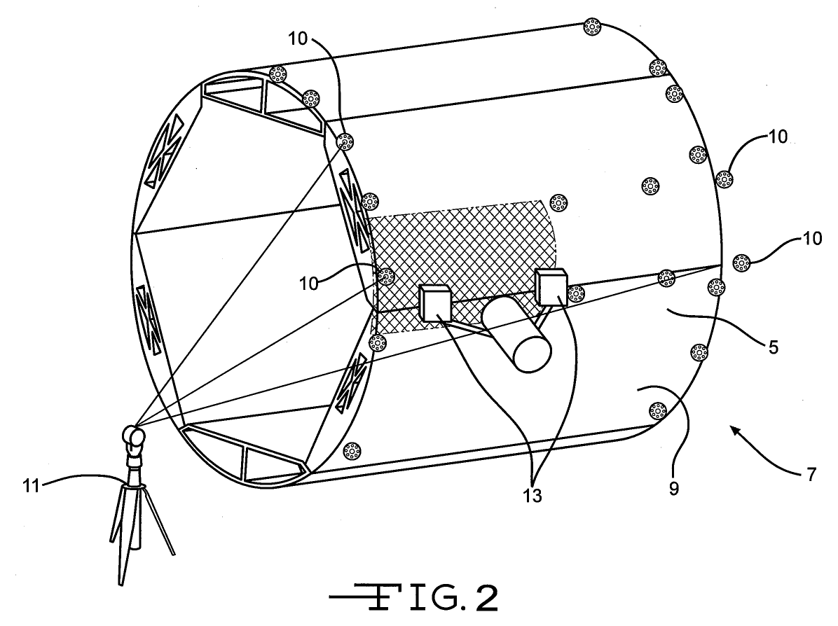

In one embodiment of the invention, as shown in FIG. 1, a target 10 for use in measuring surfaces may have a generally hemispherical shape. As shown in FIG. 2, a plurality of the target 10 of FIG. 1 may be distributed over a surface 5 of an airplane 7, which may comprise an airplane's barrel 9, to measure the surface 5. In other embodiments, one or more targets 10 may be used to measure one or more surfaces in non-airplane applications. One or more locations of the targets 10, distributed over surface 5, may be measured utilizing a combination of a laser tracking device 11 and a photogrammetry device 13. The measured locations of the targets 10 may be utilized to determine the measurements of the surface 5.

In one embodiment, the photogrammetry device 13 may comprise one or more V-Star cameras. In other embodiments, the photogrammetry device 13 may comprise any photogrammetry device known in the art. The target 10 may be made of steel, and may have a diameter 12 substantially in the range of one-half of an inch to two inches. In other embodiments, the target 10 may be made of any material known in the art, and may be in differing shapes, sizes, orientations, and configurations.

The target 10 may comprise a first portion 14 and a second portion 32. The first portion 14 may comprise one or more surfaces 15 which are adapted to reflect a laser beam towards laser tracking device 11. In one embodiment, the first portion 14 may comprise three reflective mirrors 18 attached to a generally spherical surface 20. The first portion 14 may comprise a spherical magnetic reflector (SMR). In other embodiments, any number of mirrors 18 may be utilized, and the mirrors 18 may be attached to differing sized and shaped surfaces of the target 10. In still other embodiments, the first portion 14 may comprise one or more non-mirror reflective surfaces.

The generally spherical surface 20 may have a diameter 22 in the range of one-eighth of an inch to one-inch. In other embodiments, the diameter 22 of the spherical surface 20 may be in varying sizes. The first portion 14 may be located in a center 23 of a surface 24 of the target 10. In other embodiments, first portion 14 may be located in varying portions of the target 10.

The first portion 14 may be attached to the target 10 utilizing one or more magnets (not shown). The one or more magnets may be attached to a surface of an aperture 30 in the target 10 utilizing adhesive, a snap-fit, or other devices known in the art. Aperture 30 may be centrally located with respect to target 10. In other embodiments, first portion 14 may be attached to the target 10 utilizing other devices known in the art. First portion 14 may be adapted to move, relative to both target 10 and second portion 32, into varying planes. The first portion 14 may be adapted to rotate in a variety of directions in order to be located in the same or different planes as second portion 32. In one embodiment, a user of target 10 may rotate first portion 14 utilizing the user's hand.

The second portion 32 may comprise one or more discrete surfaces 34 which are adapted to reflect a light beam towards a photogrammetry device 13, such as one or more V-Star cameras. In one embodiment, the second portion 32 may comprise one or more reflective surfaces 34, adhered to one or more surfaces 24 of the target 10. In other embodiments, reflective surfaces 34 may be attached to target 10 utilizing any manner known in the art. Reflective surfaces 34 may be made of retro-reflective material. In other embodiments, reflective surfaces 34 may be made of any reflective material known in the art.

The reflective surfaces 34 may comprise a plurality of discrete, generally circular, reflective surfaces (dots). In other embodiments, the reflective surfaces 34 may comprise three to seven generally circular, reflective surfaces (dots). In still other embodiments, the reflective surfaces 34 may comprise three to ten generally circular, reflective surfaces (dots). The generally circular, reflective surfaces (dots) may have diameters in the range of one-tenth of an inch to one-half of an inch. In still other embodiments, any number of reflective surfaces 34 may be utilized in any shape, location, orientation, size, or configuration. The second portion 32 may be evenly distributed around first portion 14. First and second portions 14 and 32 may share a common central point 38 which may be located in a center of target 10. In one embodiment, first portion 14 may be located in a central area 42 with respect to a plurality of reflective surfaces 34, and target 10. In other embodiments, first and second portions 14 and 32 may be located in a variety of locations, configurations, and orientations with respect to target 10 and with respect to one another.

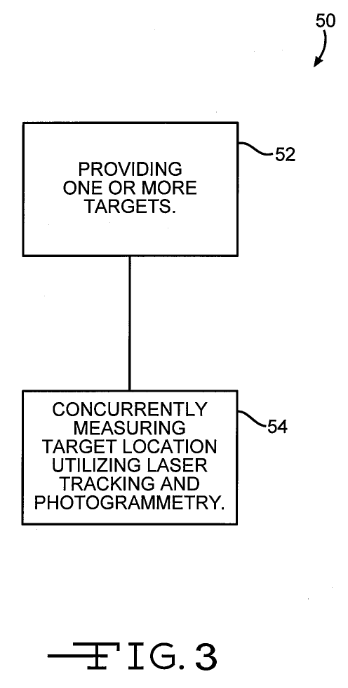

In another embodiment of the invention, as depicted in FIG. 3, a method 50 for measuring a surface may be provided. The surface to be measured may comprise one or more parts of an airplane. In other embodiments, the surface to be measured may comprise a non-airplane application. One step 52 of the method may comprise providing one or more targets. The provided targets may comprise any of the embodiments of the target 10 disclosed within this specification. In one embodiment, each of the one or more targets 10 may comprise a first reflective portion 14 and a second reflective portion 32.

The provided targets may be distributed over various portions of the surface to be measured. In one embodiment, eighteen targets may be distributed around the circumference of an aft end of a barrel of an airplane, and another eighteen targets may be distributed around the circumference of the forward end of the barrel. In yet another embodiment, substantially in the range of twenty-five to forty-five targets may be distributed around the surface to be measured. In still other embodiments, any number of targets may be located on or in any portion of the surface to be measured.

Another step 54 of the method may comprise concurrently measuring one or more locations of one or more targets utilizing both laser tracking and photogrammetry. In one embodiment, the step 54 may comprise measuring X plane, Y plane, and/or Z plane locations of one or more targets. In other embodiments, step 54 may comprise taking varying measurements of one or more target locations. During step 54, a light emitting device, such as a Prospot, may emit one or more light beams onto the surface to be measured. The one or more light beams emitted by the Prospot may take the shape of a multitude of dots, in any size or shape, distributed over the surface to be measured. In one embodiment, hundreds of light-beam dots may be directed onto the surface to be measured. The emitted light-beam dots may act as a grid system to locate one or more targets with respect to various portions of the measured surface.

During step 54, the first reflective portion of the one or more targets may reflect one or more laser beams emitted from one or more laser tracking devices back towards the one or more laser tracking devices. Simultaneously, the second reflective portion of the one or more targets may reflect one or more light beams emitted from one or more photogrammetry devices back towards the one or more photogrammetry devices. The photogrammetry devices may comprise one or more V-Star cameras. By simultaneously utilizing both photogrammetry and laser tracking, one or more location measurements of one or more targets may be arrived at using combined photogrammetry and laser tracking measurements.

The photogrammetry and laser tracking measurements may be combined into one or more measurements of the targets utilizing one or more computers to interactively communicate and determine the one or more combined target measurements. The one or more combined target measurements may be utilized to determine one or more measurements of the surface. In one embodiment, measurements of the surface may be determined in the X plane, the Y plane, and/or the Z plane. In other embodiments, varying measurements of the surface may be determined.

Combining two inspection technologies, laser tracking and photogrammetry, to determine a surface's measurements may provide more accurate measurements, more efficient measurements, more timely measurements, and/or less costly measurements.

It should be understood, of course, that the foregoing relates to exemplary embodiments of the invention and that modifications may be made without departing from the spirit and scope of the invention as set forth in the following claims.

We claim:

1. A method for measuring a surface comprising:
providing a target; and
concurrently measuring a location of said target utilizing laser tracking and photogrammetry.

2. The method of claim 1, wherein the method is used to measure a surface comprising a part of an airplane.

3. The method of claim 1, wherein said target comprises a first reflective portion and a second reflective portion.

4. The method of claim 3, wherein during the step of measuring the location of said target the first reflective portion reflects a laser beam towards a laser tracking device and the second reflective portion reflects a light beam towards a photogrammetry device.

5. The method of claim 1, wherein the measurement of said surface is based on the measured location of said target.

6. The method of claim 1, wherein a plurality of targets are provided and, in an additional step, said targets are distributed throughout said surface.

7. The method of claim 1, wherein one or more V-Star photogrammetry cameras are utilized during the measuring step.

8. The method of claim 1, wherein during the measuring step at least one of the laser tracking and the photogrammetry measurements are communicated interactively with the other.
